(19) United States
(12) Patent Application Publication
(10) Pub. No.: US 2024/0059188 A1
(43) Pub. Date: Feb. 22, 2024

(54) METHOD FOR CONTROLLING A BATTERY UNIT OF A MOTOR VEHICLE

(71) Applicant: Dr. Ing. h.c. F. Porsche Aktiengesellschaft, Stuttgart (DE)

(72) Inventor: Daniel Simon, Ludwigsburg (DE)

(21) Appl. No.: 18/230,071

(22) Filed: Aug. 3, 2023

(30) Foreign Application Priority Data
Aug. 16, 2022 (DE) 10 2022 120 565.7

(51) Int. Cl. B60L 58/22; B60L 58/12; B60L 50/60

(52) U.S. Cl. CPC B60L 58/22; B60L 58/12; B60L 50/60; B60L 2240/547

(57) ABSTRACT

A method is provided for controlling a battery unit of a motor vehicle. The battery unit is configured to provide electrical energy to an electric drivetrain (M) of the motor vehicle, and the electric drivetrain (M) is configured to drive the motor vehicle. The battery unit has a plurality of battery modules (U1, U2, UN, V1, V2, VN, W1, W2; WN). The method comprises: monitoring whether the battery unit is in a powered-off state; measuring a period of time during which the battery unit is in the powered-off state; and transitioning the battery unit from the powered-off state into a powered-on state when the period of time exceeds a time threshold. The battery modules (U1, U2, UN, V1, V2, VN, W1, W2; WN) are connected electrically in parallel to one another in the powered-on state.

### CROSS REFERENCE TO RELATED APPLICATION

This application claims priority on German Patent Application No 10 2022 120 565.7.2 filed Aug. 16, 2022, the entire disclosure of which is incorporated herein by reference.

### BACKGROUND

### Field of the Invention

The invention relates to a method for controlling a battery unit of a motor vehicle.

### Related Art

A battery unit having plural battery modules is well known in the prior art. In the context of this specification, a battery module is understood to mean a rechargeable voltage source. The battery modules of a battery unit can be connected to one another via semiconductor elements. Such battery units typically are used in an electrically driven motor vehicle to provide electrical energy to the drivetrain.

Battery modules of a battery unit often are connected parallel to one another, for example, in the case of an insulation measurement. It is also possible to interconnect battery modules parallel to one another for quickly providing more power for the drivetrain, for example, if a higher acceleration of the motor vehicle is desired.

Voltage differentials of the battery modules must not become too large when operating with the battery modules connected in parallel. If voltage differentials are too large, comparatively large equalizing currents occur in the parallel circuit due to the capacities present in the circuit and the low-ohmic connection between the battery modules.

DE 10 2018 004891 A1 discloses a method for voltage compensation in the on-board network of an electrically operated vehicle. This method includes forming a voltage differential from the sensed voltages of two batteries and powering-on a consumption to the battery whose sensed voltage lies outside a target voltage range. The method then discharges the battery until the voltage is within the target voltage range.

The invention addresses the problem of reducing the risk of large voltage differentials between the battery modules in case of longer downtimes of the motor vehicle.

### SUMMARY OF THE INVENTION

The invention relates to a battery unit configured to provide electrical energy to an electric drivetrain of a motor vehicle. For example, the battery unit and the drivetrain can be connected to one another via electrical leads. The electric drivetrain is configured to drive the motor vehicle. The battery unit comprises a plurality of battery modules.

A method in accordance with one aspect of the invention includes monitoring whether the battery unit is in a powered-off state. In the context of this specification, the powered-off state is understood to mean that the battery unit is separated by switching elements from electrical consumers, such as from the drivetrain of the motor vehicle. The method further includes measuring a time during which the battery unit is in the powered-off state and comparing the measured time to a time threshold. If the measured time exceeds the time threshold, the method proceeds by transitioning the battery unit from the powered-off state into a powered-on state. The battery modules are connected electrically in parallel to one another when powered-on. The powered-on state in the context of this specification is understood to mean that the battery unit is connected electrically to at least one electrical consumer. Some embodiments of the method are carried out so that, in the powered-on state, the battery unit can be connected electrically, for example via a low-voltage tap, to an on-board network of the motor vehicle, that has an operating voltage less than the voltage provided by the battery unit. Various electrical consumers can be a component part of this on-board network.

The voltages of the battery modules inherently are matched to one another by transitioning into the powered-on state with battery modules connected in parallel and with the electrical connection to the on-board network. In this way, the risk of large voltage differentials between the battery modules is reduced when the motor vehicle is not used for an extended period of time, because the individual battery modules are also discharged at different rates when powered-off.

According to one embodiment, the time threshold can be constant. In this way, the battery unit can be switched to the powered-on state at regular intervals during an extended downtime of the motor vehicle and voltage differentials between the battery modules are thus compensated.

According to one embodiment, the time threshold can be changed. For example, the time threshold can be changed after the battery unit has been transitioned back from the powered-on state into the powered-off state. Thus, electrical voltages present on the battery modules can be monitored in the powered-on state. The time threshold can be decreased upon detection that a voltage differential between a highest one of the voltages and a lowest one of the voltages is greater than a first battery module threshold. Thus, the time threshold can be adapted to how quickly the battery modules discharge differently.

The time threshold can be increased upon detection that the voltage differential between the highest of the voltages and the lowest of the voltages is less than a second battery module threshold. In this way, unnecessary transitions into the powered-on state can be avoided.

According to one embodiment, the battery unit can be configured to output an AC voltage. For this purpose, the battery unit can comprise an inverter. The inverter can comprise several components and does not have to be a separate component.

According to one embodiment, the battery unit can be configured to output a DC voltage.

In one embodiment, after powering the unit on, an insulation measurement can be carried out with the battery modules connected in parallel. In the context of this specification, an insulation measurement is understood to mean a measurement of the insulation resistance of the circuit to which the battery unit is electrically connected. The parallel connection of the battery modules to one another can be part of the insulation measurement. In this way, the parallel circuitry can be accomplished by an operation already implemented in the control unit for the battery unit.

The insulation measurement can alternatively be carried out when the battery modules are interconnected in a bypassing manner.

According to one embodiment, after transitioning to the powered-on state, a respective voltage of the battery modules can be measured. The parallel circuitry of the battery modules and the powered-on state can be maintained until a difference between a highest one of the voltages and a lowest one of the voltages is less than a voltage threshold. This has the advantage that the parallel circuitry is maintained for a sufficient length of time to match the voltages to the desired extent.

In one embodiment, a state of charge of the battery modules can be determined upon powering the unit on. This can be done directly after powering the unit on and even before the insulation measurement. The state of charge can be determined via, for example, the open circuit voltage and the cell temperature. The respective state of charge significantly affects the voltage of the respective battery module. Preferably, voltage differentials between the battery modules are determined to ensure that a parallel circuitry of the battery modules is possible without the risk of damage.

The disclosure also relates to a control unit for a battery unit of a motor vehicle. The control unit is configured to carry out a method according to one embodiment of the invention.

The disclosure also relates to a system that comprises the above-described control unit and the battery unit.

Further features and advantages of the invention become apparent from the following description of preferred embodiments, with reference to the appended illustrations. The same reference numerals are used for the same or similar components and for components having the same or similar functions.

### BRIEF DESCRIPTION OF THE DRAWINGS

FIG. 1 is a schematic circuit diagram of a system according to one embodiment of the invention.

FIG. 2 is a schematic circuit diagram of an embodiment of a battery module.

FIG. 3 a schematic circuit diagram of an alternative embodiment of a battery module.

### DETAILED DESCRIPTION

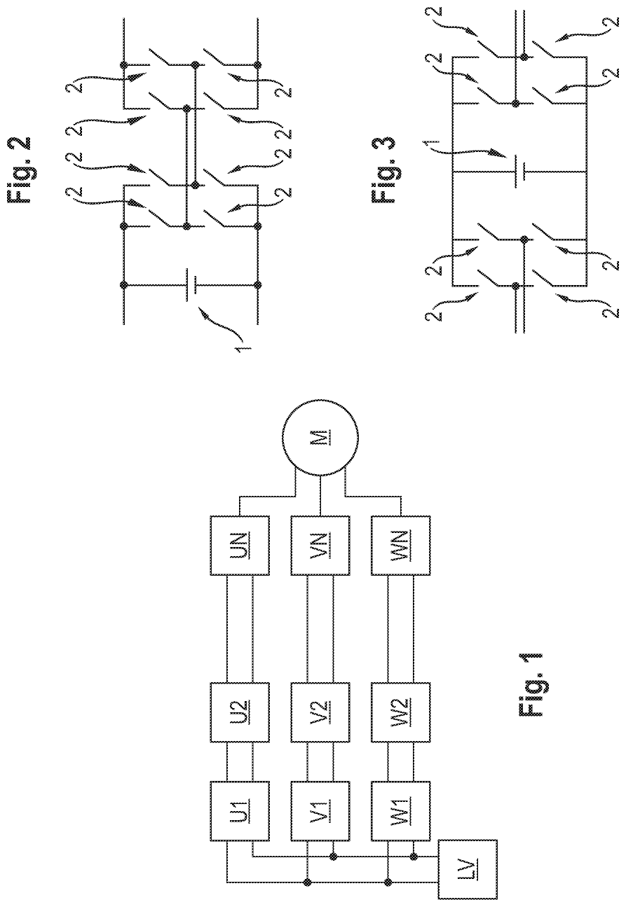

The system of FIG. 1 is a component of a motor vehicle and comprises a battery unit having a plurality of battery modules U1, U2, UN, V1, V2, VN, W1, W2, and WN, a drivetrain M, and a low-voltage tap LV. The battery modules U1, U2, UN, V1, V2, VN, W1, W2, and WN are connected electrically via the low-voltage tap LV to an on-board network of the motor vehicle. The on-board network has a lower voltage than the voltage supplied by the battery modules.

The battery modules U1, U2, UN, V1, V2, VN, W1, W2, and WN also are connected electrically to the drivetrain M and are configured to provide electrical energy to the drivetrain M. The drivetrain M is configured to drive the motor vehicle.

FIGS. 2 and 3 show possible embodiments of the battery modules U1, U2, UN, V1, V2, VN, W1, W2, and WN. Each embodiment comprises a voltage source 1 and switching elements 2. The switching elements 2 can be semiconductor switching elements, for example metal-oxide-semiconductor field-effect transistors (MOSFETs). The battery modules U1, U2, UN, V1, V2, VN, W1, W2, and WN can be connected to one another in different ways via suitable circuitry of the switching elements 2.

If the motor vehicle is not used for an extended period of time, the voltage sources 1 discharge at different rates, such that they have differently high voltages upon powering-on of the motor vehicle. Putting the motor vehicle is put into service with relatively large differences in voltages of the voltage sources 1 creates a risk of large equalizing currents that can damage the battery modules or other components.

Therefore, the battery unit of this disclosure is transitioned into a powered-on state with battery modules U1, U2, UN, V1, V2, VN, W1, W2, and WN connected to one another in parallel when the battery unit has been in a powered-off state for a period of time that exceeds a time threshold. When the battery modules U1, U2, UN, V1, V2, VN, W1, W2, and WN are connected in parallel to one another, the voltages are matched to one another. The parallel circuitry of the battery modules can be achieved by a suitable circuitry of the switching elements 2.

In this way, an adjustment of the state of charges of the battery modules U1, U2, UN, V1, V2, VN, W1, W2, and WN and thus the voltages of the battery modules U1, U2, UN, V1, V2, VN, W1, W2, and WN can be achieved without additional measurements. It is particularly advantageous when the powered-on state with the battery modules U1, U2, UN, V1, V2, VN, W1, W2, and WN connected in parallel is a mode already provided in the control unit with battery modules U1, U2, UN, V1, V2, VN, W1, W2, and WN connected in parallel. This mode can be provided, for example, to perform an insulation measurement.

1. A method for controlling a battery unit of a motor vehicle, wherein the battery unit is configured to provide electrical energy to an electric drivetrain (M) of the motor vehicle, the electric drivetrain (M) being configured to drive the motor vehicle, the battery unit comprising a plurality of battery modules (U1, U2, UN, V1, V2, VN, W1, W2; WN), the method comprising:
monitoring whether the battery unit is in a powered-off state;
measuring a period of time during which the battery unit is in the powered-off state; and
transitioning the battery unit from the powered-off state into a powered-on state when the period of time exceeds a time threshold, wherein the battery modules (U1, U2, UN, V1, V2, VN, W1, W2; WN) are connected electrically in parallel to one another in the powered-on state.

2. The method of claim 1, wherein the time threshold is constant.

3. The method of claim 1, wherein the time threshold is changeable.

4. The method of claim 1, wherein the battery unit is configured to output an AC voltage.

5. The method of claim 1, wherein the battery unit is configured to output a DC voltage.

6. The method of claim 1, wherein, after powering the battery unit on, an insulation measurement is carried out with the battery modules connected in parallel (U1, U2, UN, V1, V2, VN, W1, W2; WN).

7. The method of claim 1, wherein, after transitioning the battery unit into the powered-on state, a voltage on each of the battery modules (U1, U2, UN, V1, V2, VN, W1, W2; WN) is measured, wherein the parallel circuitry of the battery modules (U1, U2, UN, V1, V2, VN, W1, W2; WN) and the powered-on state are maintained until a difference between a highest of the voltages and a lowest of the voltages is less than a voltage threshold.

8. The method of claim 1, characterized in that a state of charge of the battery modules (U1, U2, UN, V1, V2, VN, W1, W2; WN) is determined after powering the battery unit on.

9. A control unit for a battery unit of a motor vehicle, wherein the control unit is configured to carry out the method of claim 1.

10. A system comprising the control unit and the battery unit of claim 9.
